(19) United States
(12) Patent Application Publication
(10) Pub. No.: US 2015/0035869 A1
(43) Pub. Date: Feb. 5, 2015

(54) LIQUID CRYSTAL DISPLAY

(71) Applicant: Sharp Kabushiki Kaisha, Osaka-shi, Osaka (JP)

(72) Inventors: Tomohiko Mori, Osaka (JP); Kazunari Tomizawa, Osaka (JP); Makoto Hasegawa, Osaka (JP); Yuichi Yoshida, Osaka (JP)

(21) Appl. No.: 14/378,188

(22) PCT Filed: Feb. 13, 2013
(86) PCT No.: PCT/JP2013/053359

§ 371 Date: Aug. 12, 2014

(30) Foreign Application Priority Data
Feb. 15, 2012 (JP) 2012-031039

(51) Int. Cl. G09G 3/20; G09G 3/36

(52) U.S. Cl. CPC G09G 3/2007; G09G 3/36; G09G 2320/0247; G09G 2320/0233; G09G 2320/0271; G09G 2320/068
USPC 345/690; 345/89

(57) ABSTRACT

In a display apparatus having a liquid crystal panel, a change in luminance of the entire display frame when overshoot driving is performed is suppressed, while improving a viewing angle of the liquid crystal panel. A processing unit performs a high gradation display displaying a gradation higher than a gradation of an input image at one of two adjacent pixels, performs a low gradation display displaying a gradation lower than a gradation of an input image at the other of the two adjacent pixels, and switches between the high gradation display and the low gradation display for each pixel every display frame. A correction unit corrects a gradation of a pixel located adjacent to a pixel displayed with a gradation for which predetermined overshoot driving is difficult in the next display frame to a gradation for which overshoot driving stronger than the predetermined overshoot driving is possible.

### TECHNICAL FIELD

The present invention relates to a liquid crystal display apparatus including a liquid crystal panel, particularly, to a liquid crystal display apparatus having an improved viewing angle for a liquid crystal panel.

### BACKGROUND ART

There is known a liquid crystal display apparatus provided with a liquid crystal panel. Improvement of a viewing angle of the liquid crystal panel for the liquid crystal display apparatus has been suggested. For example, an image processing method for changing a gradation in a time division manner (for example, every display frame) is disclosed in International Publication No. 2010/71221.

In the image processing method described in the above-mentioned Publication, an image with a high gradation and an image with a low gradation are alternately displayed. Therefore, it is possible to improve the viewing angle of the liquid crystal display.

However, if the image processing method described in the above-mentioned Publication is performed, the gradation (luminance of an entire display frame) of an entire image significantly changes. For this reason, flicker is likely to be generated.

In order to resolve such a flicker issue, a method has been considered in which a high gradation display and a low gradation display are performed at adjacent pixels of the liquid crystal panel, and the high gradation display and the low gradation display are switched between in a time division manner for each pixel. Accordingly, the gradation of the entire image does not significantly change. Therefore, it is possible to prevent the occurrence of the above-described flicker.

Meanwhile, in the liquid crystal display apparatus, performing overshoot driving has been suggested to improve the response speed of the liquid crystal panel. (For example, refer to International Publication No. 2006/98244)

However, when the high gradation display and the low gradation display are switched between, it is not possible to perform overshoot driving in some cases. Specifically, for example, in a case where the gradation after switching is a maximum gradation or a minimum gradation, it is not possible to perform overshoot driving. In this case, the luminance of the entire display frame becomes a luminance different from a predetermined luminance.

### CITATION LIST

### Patent Literature

PTL 1: International Publication No. 2010/71221

PTL 2: International Publication No. 2006/98244

### SUMMARY OF INVENTION

### Technical Problem

An object of the present invention is to provide a liquid crystal display apparatus that can suppress a change in luminance of the entire display frame when overshoot driving is performed, while improving a viewing angle of a liquid crystal panel.

### Solution to Problem

A liquid crystal display apparatus according to an embodiment of the invention includes a liquid crystal panel and a viewing angle improvement unit. The liquid crystal panel has a plurality of pixels disposed in a matrix pattern. The viewing angle improvement unit performs a process of improving a viewing angle of the liquid crystal panel. The viewing angle improvement unit has a processing unit and a correction unit. The processing unit performs a high gradation display displaying a gradation higher than a gradation of an input image at one of two adjacent pixels, performs a low gradation display displaying a gradation lower than a gradation of an input image at the other of the two adjacent pixels, and switches between the high gradation display and the low gradation display for each pixel every display frame. The correction unit corrects a gradation of a pixel located adjacent to a pixel displayed with a gradation for which predetermined overshoot driving is difficult in the next display frame to a gradation for which overshoot driving stronger than the predetermined overshoot driving is possible. When there is a pixel displayed with a gradation for which predetermined overshoot driving is difficult, the processing unit displays a pixel located adjacent to a pixel displayed with a gradation for which predetermined overshoot driving is difficult, with the gradation corrected by the correction unit.

### Advantageous Effects of Invention

According to an embodiment of the present invention, it is possible to suppress a change in luminance of the entire display frame when overshoot driving is performed, while improving a viewing angle of a liquid crystal panel.

### BRIEF DESCRIPTION OF DRAWINGS

FIG. 1 is a block diagram of a schematic configuration of a liquid crystal display apparatus according to an embodiment of the invention.

FIG. 2 is a diagram showing a difference in gradation levels according to a difference in a viewing direction of a liquid crystal panel.

FIG. 3 is a diagram showing an outline of a process of improving a viewing angle.

FIG. 4 is a diagram showing an example of a gradation conversion that is performed by a converting unit.

FIG. 5 is a diagram showing a case where a first half is a low gradation display and a latter half is a high gradation display when a gradation of an input image is lower than a threshold gradation.

FIG. 6 is a diagram showing a case where a first half is a low gradation display and a latter half is a high gradation display when a gradation of an input image is a threshold gradation.

FIG. 7 is a diagram showing a case where a first half is a low gradation display and a latter half is a high gradation display when a gradation of an input image is higher than a threshold gradation.

FIG. 8 is a diagram showing a case where a first half is a high gradation display and a latter half is a low gradation display when a gradation of an input image is lower than a threshold gradation.

FIG. 9 is a diagram showing a case where a first half is a high gradation display and a latter half is a low gradation display when a gradation of an input image is a threshold gradation.

FIG. 10 is a diagram showing a case where a first half is a high gradation display and a latter half is a low gradation display when a gradation of an input image is higher than a threshold gradation.

FIG. 11 is a time chart illustrating overshoot driving when a display mode switches from a display mode 1 to a display mode 3.

FIG. 12 is a time chart illustrating overshoot driving when the display mode 3 is continued.

FIG. 13 is a time chart illustrating overshoot driving when a display mode 4 is continued.

FIG. 14 is a time chart illustrating overshoot driving when a display mode switches from a display mode 6 to the display mode 4.

### DESCRIPTION OF EMBODIMENTS

A liquid crystal display apparatus according to an embodiment of the invention includes a liquid crystal panel and a viewing angle improvement unit. The liquid crystal panel has a plurality of pixels disposed in a matrix pattern. The viewing angle improvement unit performs a process of improving a viewing angle of the liquid crystal panel. The viewing angle improvement unit has a processing unit and a correction unit. The processing unit performs a high gradation display displaying a gradation higher than a gradation of an input image at one of two adjacent pixels, performs a low gradation display displaying a gradation lower than a gradation of an input image at the other of the two adjacent pixels, and switches between the high gradation display and the low gradation display for each pixel every display frame. The correction unit corrects a gradation of a pixel located adjacent to a pixel displayed with a gradation for which predetermined overshoot driving is difficult in the next display frame to a gradation for which overshoot driving stronger than the predetermined overshoot driving is possible. When there is the pixel displayed with a gradation for which predetermined overshoot driving is difficult, the processing unit displays a pixel located adjacent to the pixel displayed with a gradation for which predetermined overshoot driving is difficult, with the gradation corrected by the correction unit (a first configuration).

In the first configuration, the high gradation display and the low gradation display are switched between every display frame. Therefore, the viewing angle of the liquid crystal panel is improved.

Here, in the first configuration, the high gradation display is performed at one of two adjacent pixels, the low gradation display is performed at the other of the two adjacent pixels, and the high gradation display and the low gradation display are switched between pixel by pixel. For this reason, luminance of the entire display frame does not significantly change. As a result, the occurrence of a flicker is suppressed.

In a case where response speed of the liquid crystal panel is improved, overshoot driving is performed. In a case where overshoot driving is performed, if the low gradation display switches to the high gradation display, a gradation higher than a gradation to be displayed is set as a target gradation. In a case where overshoot driving is performed, if the high gradation display switches to the low gradation display, a gradation lower than a gradation to be displayed is set as a target gradation.

Here, when the high gradation display and the low gradation display are switched between, the predetermined overshoot driving may become difficult. For example, in a case where a gradation to be displayed is a maximum gradation when the low gradation display switches to the high gradation display, or in a case where a gradation to be displayed is a minimum gradation when the high gradation display switches to the low gradation display, it is not possible to set the target gradation when overshoot driving is performed. For this reason, it is not possible to perform the predetermined overshoot driving.

Further, even when the gradation to be displayed is not the maximum gradation or the minimum gradation, in a case where the gradation to be displayed is a gradation close to the maximum gradation or the minimum gradation, it is not possible to set the target gradation when overshoot driving is performed as a gradation to be an original target. For this reason, it is not possible to perform the predetermined overshoot driving.

The luminance of a pixel displayed with a gradation for which predetermined overshoot driving is difficult is different from a predetermined luminance. For this reason, in a case where there is a pixel displayed with a gradation for which predetermined overshoot driving is difficult, the luminance of the entire display frame becomes a luminance different from the predetermined luminance.

Here, in the first configuration, in a case where there is a pixel displayed with a gradation for which predetermined overshoot driving is difficult, a gradation of a pixel located adjacent thereto is corrected to a gradation for which overshoot driving stronger than the predetermined overshoot driving is possible. That is, it is possible to compensate for a change in luminance at a pixel displayed with a gradation for which predetermined overshoot driving is difficult by changing luminance of a pixel located adjacent thereto. As a result, it is possible to make the luminance of the entire display frame close to the predetermined luminance.

In addition, the predetermined overshoot driving is overshoot driving for achieving a gradation to be originally displayed in the display frame.

In the first configuration, when the gradation of an input image is lower than the threshold gradation, after performing the high gradation display with an intermediate gradation higher than the minimum gradation and lower than the maximum gradation, the processing unit performs the low gradation display with the minimum gradation. When the gradation of an input image is higher than the threshold gradation, after performing the high gradation display with the maximum gradation, the processing unit performs the low gradation display with the intermediate gradation (a second configuration).

In the second configuration, the correction unit corrects a gradation of a pixel located adjacent to a pixel switched from the low gradation display when the gradation of an input image is lower than the threshold gradation to the high gradation display when the gradation of an input image is higher than the threshold gradation, to a gradation for which overshoot driving stronger than the predetermined overshoot driving is possible (a third configuration).

In a second configuration, the correction unit corrects a gradation of a pixel located adjacent to a pixel switched from the low gradation display when a gradation of an input image is higher than the threshold gradation to the high gradation display when a gradation of an input image is higher than the threshold gradation, to a gradation for which overshoot driving stronger than the predetermined overshoot driving is possible (a fourth configuration).

In any one of the second to the fourth configurations, the gradation for which predetermined overshoot driving is difficult is a gradation in a predetermined range including the maximum gradation (a fifth configuration). In this case, not only when the gradation of the high gradation display switched from the low gradation display is the maximum gradation, but also when the gradation of the high gradation display switched from the low gradation display is the gradation close to the maximum gradation, it is possible to make the luminance of the entire display frame close to the predetermined luminance.

In the first configuration, when the gradation of an input image is lower than a predetermined threshold gradation, after performing the low gradation display with the minimum gradation, the processing unit performs the high gradation display with the intermediate gradation higher than the minimum gradation and lower than the maximum gradation. When the gradation of an input image is higher than the threshold gradation, after performing the low gradation display with the intermediate gradation, the processing unit performs the high gradation display with the maximum gradation (a sixth configuration).

In the sixth configuration, the correction unit corrects a gradation of a pixel located adjacent to a pixel switched from the high gradation display when the gradation of an input image is lower than the threshold gradation to the low gradation display when the gradation of an input image is lower than the threshold gradation, to a gradation for which overshoot driving stronger than the predetermined overshoot driving is possible (a seventh configuration).

In the sixth configuration, the correction unit corrects a gradation of a pixel located adjacent to a pixel switched from the high gradation display when the gradation of an input image is higher than the threshold gradation to the low gradation display when the gradation of an input image is lower than the threshold gradation, to a gradation for which overshoot driving stronger than the predetermined overshoot driving is possible (a eighth configuration).

In any one of the sixth to eighth configurations, the gradation for which predetermined overshoot driving is difficult is a gradation in a predetermined range including the minimum gradation (a ninth configuration). In this case, not only when the gradation of the low gradation display switched from the high gradation display is the minimum gradation, but also when the gradation of the low gradation display switched from the high gradation display is the gradation close to the minimum gradation, it is possible to make the luminance of the entire display frame close to the predetermined luminance.

Hereinafter, more specific embodiment of the invention will be described with reference to the drawings. The equivalent or corresponding parts are referenced by the same reference numerals and descriptions thereof will not be repeated. In the drawings to be referred to hereinafter, configurations are simplified or schematized, or some of configuration members are omitted so as to make the description easily understandable. In addition, dimension ratios between configuration members shown in each drawing are not necessarily actual dimension ratios.

### EMBODIMENT

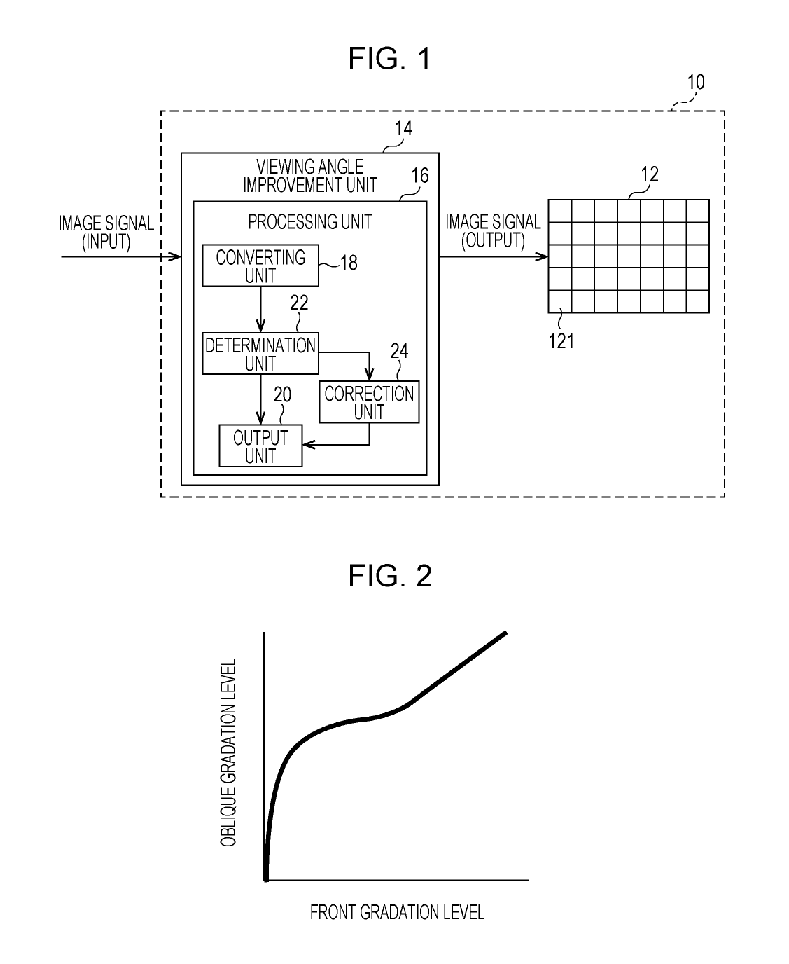

FIG. 1 shows a schematic configuration of a liquid crystal display apparatus 10 according to an embodiment of the invention. The liquid crystal display apparatus 10 includes a liquid crystal panel 12 and a viewing angle improvement unit 14. The viewing angle improvement unit 14 has a processing unit 16. The processing unit 16 has a converting unit 18, an output unit 20, a determination unit 22, and a correction unit 24. A source driver, a gate driver, and the like that drive the liquid crystal panel 12 are not shown in FIG. 1.

The liquid crystal panel 12 may be a liquid crystal panel of a transmission type, and may be a liquid crystal panel of a reflection type or a semi-transmission type. Operation modes of a liquid crystal in the liquid crystal panel 12 are not particularly limited.

The liquid crystal panel 12 has a plurality of pixels 121. The plurality of pixels 121 is disposed in a matrix pattern.

The liquid crystal panel 12 is not shown in the drawing, but has an active matrix substrate, a counter substrate that opposes to the active matrix substrate, and a liquid crystal layer that is enclosed between the active matrix substrate and the counter substrate.

The active matrix substrate has a plurality of thin film transistors, a plurality of pixel electrodes, a plurality of gate wirings, and a plurality of source wirings. The counter substrate has a counter electrode. The pixels 121 included in the liquid crystal panel 12 are configured to each have a pixel electrode included in the active matrix substrate.

Each thin film transistor has a gate electrode. The gate electrode is connected to the gate driver via the gate wiring. The gate driver outputs a gate voltage to the gate wiring while referring to a vertical synchronization signal.

Each thin film transistor has a source electrode. The source electrode is connected to the source driver via the source wiring. The source driver generates a signal (driving voltage) necessary for the gradation display based on an input image signal. The source driver outputs the driving voltage to the source wiring while referring to a horizontal synchronization signal. In this case, the driving voltage is applied to the liquid crystal disposed between the pixel electrode and the counter electrode via the thin film transistor in which the gate voltage is applied to the gate electrode. Accordingly, it is possible to perform the gradation display in each pixel.

The viewing angle improvement unit 14 converts a gradation of the input image signal, outputs the converted gradation to the liquid crystal panel 12, and improves viewing angle characteristics of the liquid crystal panel 12.

Here, the viewing angle characteristics of the liquid crystal panel 12 will be described with reference to FIG. 2. The liquid crystal panel 12 applies a voltage to the liquid crystal layer, changes the orientation state of liquid crystal molecules inside the liquid crystal layer, and thus controls light transmittance. The liquid crystal panel 12 relatively changes the orientation state of the liquid crystal molecules according to viewing orientation with respect to a display surface. For this reason, the viewing angle is narrow compared to other display apparatuses. For example, as shown in FIG. 2, a gradation level (oblique gradation level) in a case where the display surface is seen in an oblique direction (for example, 45 degrees) is a gradation level different from a gradation level (front gradation level) in a case where the display surface is seen from the front.

Such viewing angle characteristics of the liquid crystal panel 12 are improved by an image processing method described below.

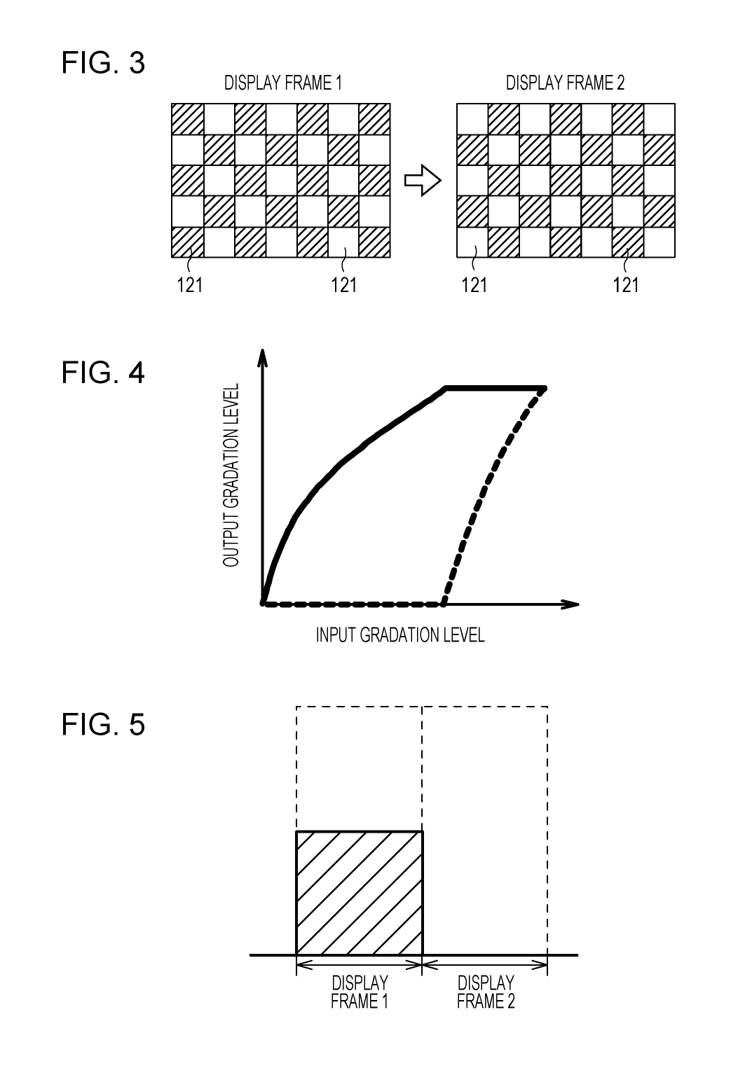

As shown in FIG. 3, the processing unit 16 performs the high gradation display (oblique part of FIG. 3) and the low gradation display (white part of FIG. 3) at adjacent pixels 121, and switches between the high gradation display and the low gradation display every display frame (display frames 1 and 2 of FIG. 3). Accordingly, in each display frame, the gradation of each pixel 121 is converted to a gradation in which significant change in gradation and color is difficult even when the display surface is seen in an oblique direction. As a result, the viewing angle characteristics of the liquid crystal panel 12 are improved. In addition, even when such an image processing method is performed, the luminance of the entire display frame is recognized as an average luminance of all the pixels. For this reason, the luminance of the image displayed on the liquid crystal panel 12 is not significantly different from a predetermined luminance (luminance of an input image).

Here, the converting unit 18 converts the gradation of an input image to a gradation higher than the gradation of the input image and a gradation lower than the gradation of the input image such that the luminance of an output image is the target luminance. For example, the relationship between the gradation of an input image and the gradation of an output image is a relationship shown in FIG. 4. In a case where the high gradation is displayed, the converting unit 18 converts the gradation of an input image based on the relationship shown by a solid line in FIG. 4. In a case where the low gradation is displayed, the converting unit 18 converts the gradation of an input image based on the relationship shown by a dashed line in FIG. 4.

More specifically, in a case where the gradation of an input image is lower than a predetermined threshold gradation, the converting unit 18 converts the gradation of the low gradation display to the minimum gradation, and converts the gradation of the high gradation display to an intermediate gradation which is higher than the minimum gradation and lower than the maximum gradation. In a case where the gradation of an input image is the threshold gradation, the converting unit 18 converts the gradation of the low gradation display to the minimum gradation, and converts the gradation of the high gradation display to the maximum gradation. In a case where the gradation of an input image is higher than the threshold gradation, the converting unit 18 converts the gradation of the low gradation display to the intermediate gradation which is higher than the minimum gradation and lower than the maximum gradation, and converts the gradation of the high gradation display to the maximum gradation. For example, in case of 256 gradations, the lowest gradation is gradation 0, the maximum gradation is gradation 255, and the threshold gradation is gradation 180. In addition, the threshold gradation appropriately changes according to response speed of the liquid crystal and the target luminance, and the like.

The output unit 20 outputs a gradation signal converted by the converting unit 18 to the liquid crystal panel 12. Accordingly, the viewing angle of the liquid crystal panel 12 is improved.

Here, the gradation signal output to the liquid crystal panel 12 by the output unit 20 will be described. In the liquid crystal panel 12, the high gradation display and the low gradation display are alternately performed at each pixel 121.

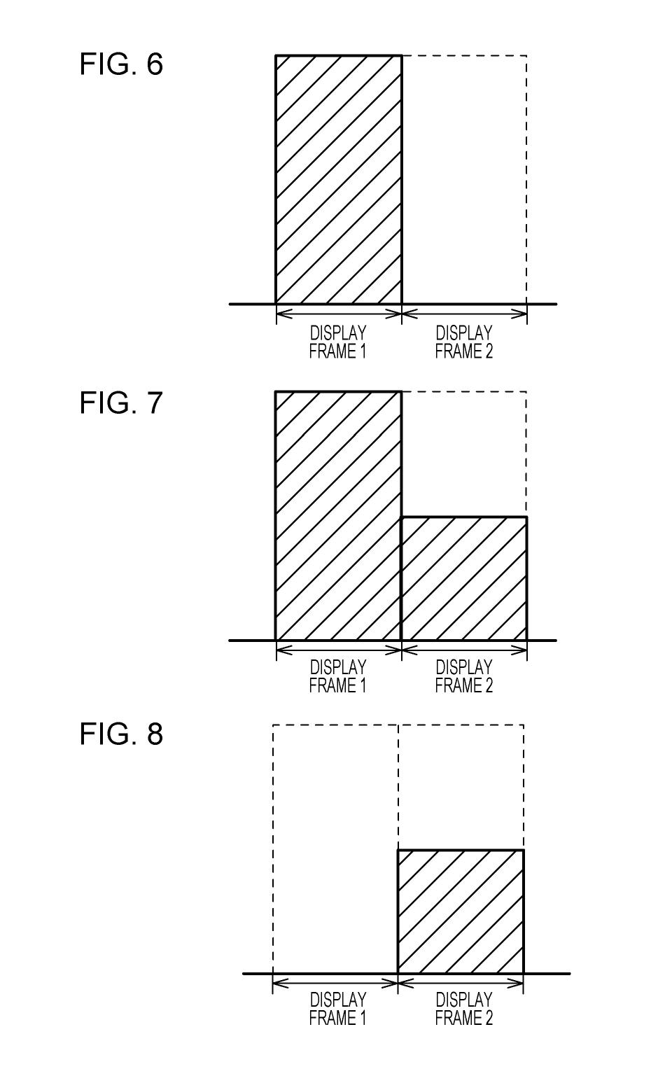

In FIG. 3, in a case of pixels 121 at which the display frame 1 is the low gradation display and the display frame 2 is the high gradation display, the output unit 20 outputs the gradation signal shown in FIGS. 5 to 7. FIG. 5 shows a case where a first half is a low gradation display and a latter half is a high gradation display (display mode 1) when the gradation of an input image is lower than the threshold gradation. FIG. 6 shows a case where a first half is a low gradation display and a latter half is a high gradation display (display mode 2) when the gradation of an input image is the threshold gradation. FIG. 7 shows a case where a first half is a low gradation display and a latter half is a high gradation display (display mode 3) when the gradation of an input image is higher than the threshold gradation.

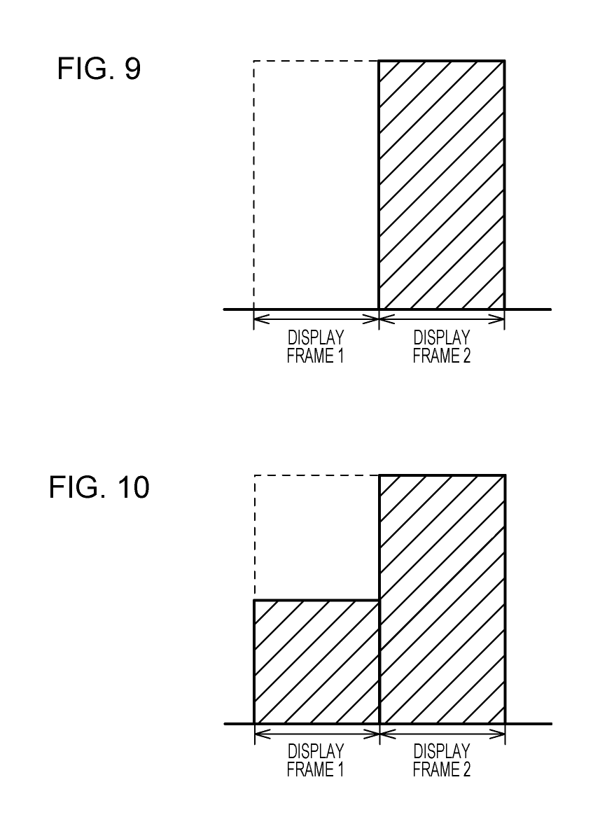

In FIG. 3, in a case of pixels 121 at which the display frame 1 is the high gradation display and the display frame 2 is the low gradation display, the output unit 20 outputs the gradation signal shown in FIGS. 8 to 10. FIG. 8 shows a case where a first half is a high gradation display and a latter half is a low gradation display (display mode 4) when the gradation of an input image is lower than the threshold gradation. FIG. 9 shows a case where a first half is a high gradation display and a latter half is a low gradation display (display mode 5) when the gradation of an input image is the threshold gradation. FIG. 10 shows a case where a first half is a high gradation display and a latter half is a low gradation display (display mode 6) when the gradation of an input image is higher than the threshold gradation.

However, the response speed of the liquid crystal panel 12 is lower than the response speed of other display panels (for example, plasma display panel). This is because the orientation of the liquid crystal molecules does not promptly change even when the voltage is applied. In order to enhance the response speed of the liquid crystal panel 12, the output unit 20 performs overshoot driving.

Here, in FIG. 3, when the gradation of the pixels 121 at which the display frame 1 is the low gradation display and the display frame 2 is the high gradation display changes, a case where the output unit 20 performs overshoot driving is considered. In this case, as shown in Table 1, at the time of a rising response, there are cases where overshoot driving cannot be performed.

TABLE 1

| | Gradation | Gradation | |
|---|---|---|---|
| | of previous | of current | Overshoot |
| Response | frame | frame | driving |
| Rising | Display | Display | ◯ |
| response | mode 1 | mode 1 | |
| | Display | Display | X |
| | mode 1 | mode 3 | |
| | Display | Display | X |
| | mode 3 | mode 3 | |
| Falling | Display | Display | ◯ |
| response | mode 1 | mode 1 | |
| | Display | Display | ◯ |
| | mode 3 | mode 1 | |
| | Display | Display | ◯ |
| | mode 3 | mode 3 | |

Hereinafter, the reason why overshoot driving cannot be performed at the time of a rising response will be described.

When performing overshoot driving at the time of a rising response, the target gradation is required to be set higher than the gradation to be displayed. However, in Table 1, in a case where the display mode 1 switches to the display mode 3 and in a case where the display mode 3 is continued, when the display frame switches, the gradation display changes from the low gradation display displaying the intermediate gradation or the minimum gradation to the high gradation display displaying the maximum gradation. It is not possible to set a gradation which is higher than the maximum gradation as a target gradation. For this reason, overshoot driving cannot be performed.

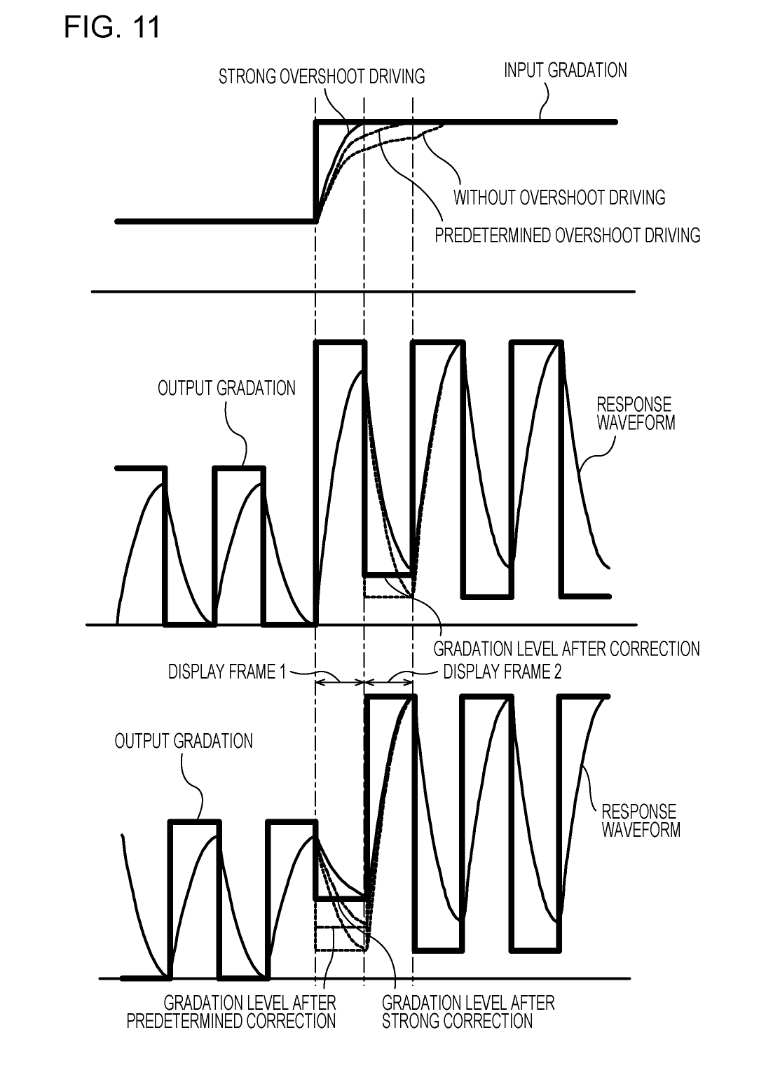

When the display mode 1 switches to the display mode 3, as shown in FIG. 11, the response of the liquid crystal is not completed during displaying period of the display frame 1. For this reason, the gradation to be originally displayed is not achieved. As a result, the luminance of the pixels deteriorates.

Here, the determination unit 22 determines whether or not there is a pixel that cannot perform overshoot driving in the display frame to be subsequently displayed.

The correction unit 24 corrects the gradation of a pixel located adjacent to a pixel for which it is determined by the determination unit 22 that overshoot driving is not possible, to a gradation for which overshoot driving stronger than the predetermined overshoot driving is possible. As shown in FIG. 11, the gradation higher than the gradation for which the predetermined overshoot driving is performed is set as a target gradation. For this reason, overshoot driving stronger than the predetermined overshoot driving is performed. As a result, the luminance of the pixel is enhanced.

That is, in the liquid crystal panel 12, it is possible to compensate for the deteriorated luminance at the pixel where overshoot driving cannot be performed by enhancing the luminance of the adjacent pixels. As a result, a change in the luminance of the entire display frame is suppressed.

The pixel which cannot perform overshoot driving in the display frame 1 can perform overshoot driving in the display frame 2. Therefore, in the display frame 2, overshoot driving is performed at the pixel where overshoot driving cannot be performed in the display frame 1.

If overshoot driving stronger than the predetermined overshoot driving is performed in the display frame 1, it is possible to obtain a waveform closer to an input gradation than a case where the predetermined overshoot driving is performed in the display frame 1.

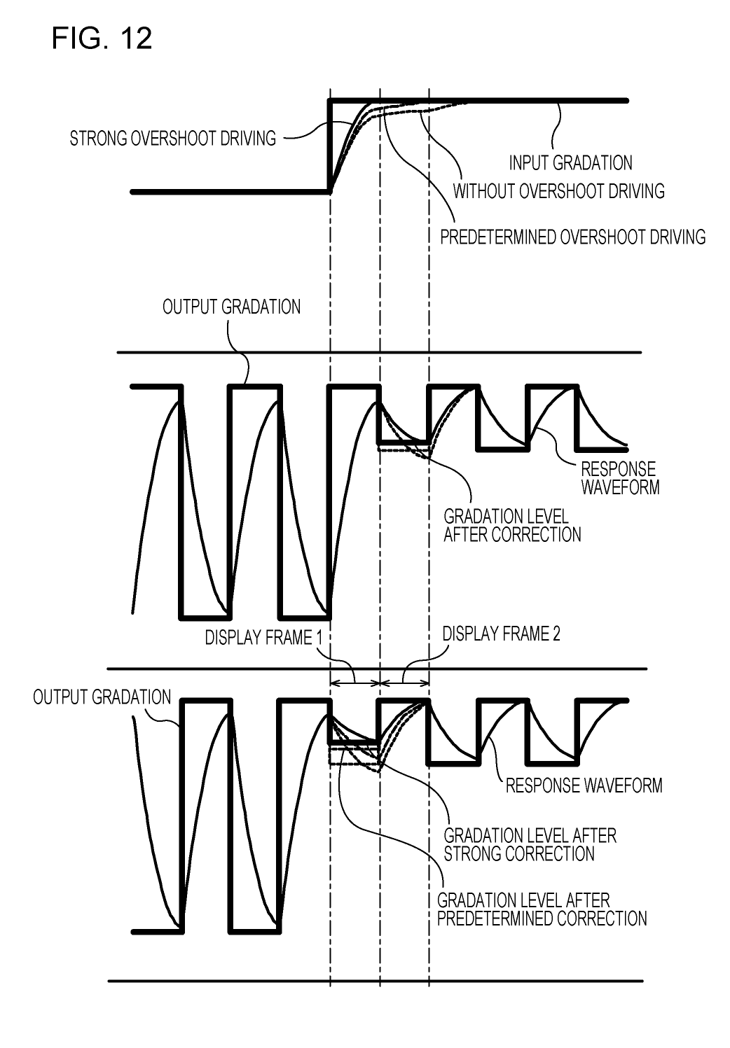

When the display mode 3 switches to the display mode 3, as shown in FIG. 12, the response of the liquid crystal is not completed during displaying period of the display frame 1. For this reason, the gradation to be originally displayed is not achieved. As a result, the luminance of the pixels deteriorates.

Here, the determination unit 22 determines whether or not there is a pixel that cannot perform overshoot driving in the display frame to be subsequently displayed.

The correction unit 24 corrects the gradation of a pixel located adjacent to a pixel which is determined by the determination unit 22 not to perform overshoot driving, to the gradation for which overshoot driving stronger than the predetermined overshoot driving is possible. As shown in FIG. 12, the gradation higher than the gradation in which the predetermined overshoot driving is performed is set as a target gradation. For this reason, overshoot driving stronger than the predetermined overshoot driving is performed. As a result, the luminance of the pixel is enhanced.

That is, it is possible to compensate for the deteriorated luminance at the pixel where overshoot driving cannot be performed by enhancing the luminance of the adjacent pixels. As a result, a change in the luminance of the entire display frame is suppressed.

The pixel which cannot perform overshoot driving in the display frame 1 can perform overshoot driving in the display frame 2. Therefore, in the display frame 2, overshoot driving is performed at the pixel where overshoot driving cannot be performed in the display frame 1.

If overshoot driving stronger than the predetermined overshoot driving is performed in the display frame 1, it is possible to obtain a waveform closer to the input gradation than a case where the predetermined overshoot driving is performed in the display frame 1.

Here, in FIG. 3, when the gradation of the pixels 121 at which the display frame 1 is the high gradation display and the display frame 2 is the low gradation display changes, a case where the output unit 20 performs overshoot driving is considered. In this case, as shown in Table 2, at the time of a falling response, there is a case where overshoot driving cannot be performed.

TABLE 2

| | Gradation | Gradation | |
|---|---|---|---|
| | of previous | of current | Overshoot |
| Response | frame | frame | driving |
| Rising | Display | Display | ◯ |
| response | mode 4 | mode 4 | |
| | Display | Display | ◯ |
| | mode 4 | mode 6 | |
| | Display | Display | ◯ |
| | mode 6 | mode 6 | |
| Falling | Display | Display | X |
| response | mode 4 | mode 4 | |
| | Display | Display | X |
| | mode 6 | mode 4 | |
| | Display | Display | ◯ |
| | mode 6 | mode 6 | |

Hereinafter, the reason why overshoot driving cannot be performed at the time of a falling response will be described.

When performing overshoot driving at the time of a falling response, the target gradation is required to be set lower than the gradation to be displayed. However, in Table 2, in a case where the display mode 4 is continued and in a case where the display mode 6 switches to the display mode 4, when the display frame switches, the gradation display changes from the high gradation display displaying the intermediate gradation or the maximum gradation to the low gradation display displaying the minimum gradation. It is not possible to set the gradation which is lower than the minimum gradation as a target gradation. For this reason, overshoot driving cannot be performed.

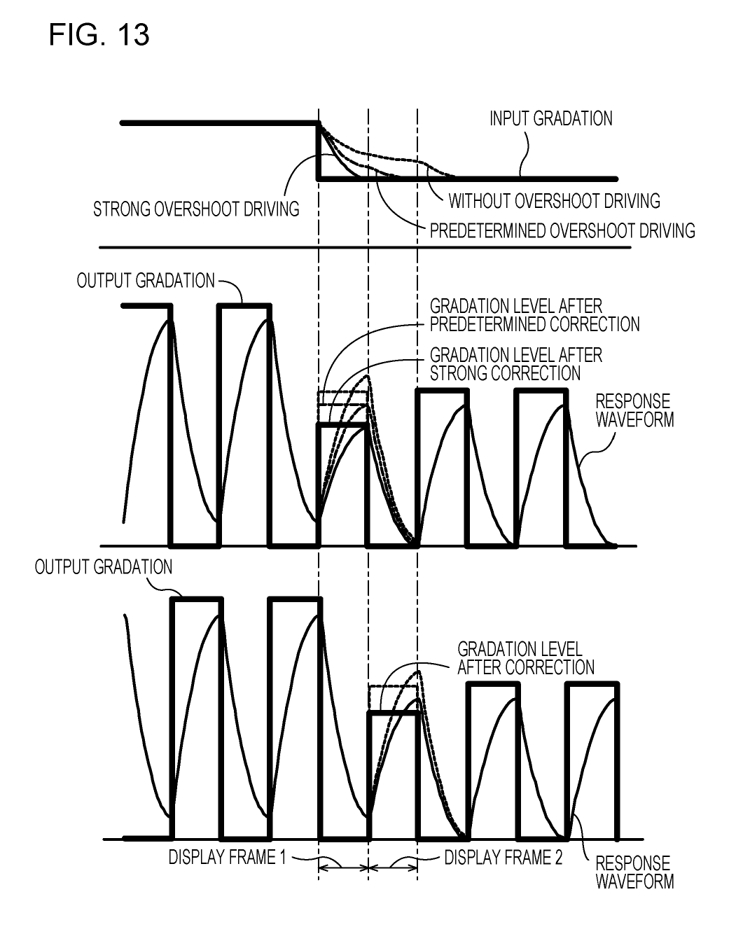

When the display mode 4 switches to the display mode 4, as shown in FIG. 13, the response of the liquid crystal is not completed during displaying period of the display frame 1. For this reason, the gradation to be originally displayed is not achieved. As a result, the luminance of the pixels is enhanced.

Here, the determination unit 22 determines whether or not there is a pixel that cannot perform overshoot driving in the display frame to be subsequently displayed.

The correction unit 24 corrects the gradation of a pixel located adjacent to a pixel which is determined by the determination unit 22 not to perform overshoot driving, to the gradation for which overshoot driving stronger than the predetermined overshoot driving is possible. As shown in FIG. 13, the gradation lower than the gradation in which the predetermined overshoot driving is performed is set as a target gradation. For this reason, overshoot driving stronger than the predetermined overshoot driving is performed. As a result, the luminance of the pixels is deteriorated.

That is, in the liquid crystal panel 12, it is possible to compensate for the enhanced luminance at the pixel where overshoot driving cannot be performed by deteriorating the luminance of the adjacent pixels. As a result, a change in the luminance of the entire display frame is suppressed.

The pixel which cannot perform overshoot driving in the display frame 1 can perform overshoot driving in the display frame 2. Therefore, in the display frame 2, overshoot driving is performed at the pixel where overshoot driving cannot be performed in the display frame 1.

If overshoot driving stronger than the predetermined overshoot driving is performed in the display frame 1, it is possible to obtain a waveform closer to the input gradation than a case where the predetermined overshoot driving is performed in the display frame 1.

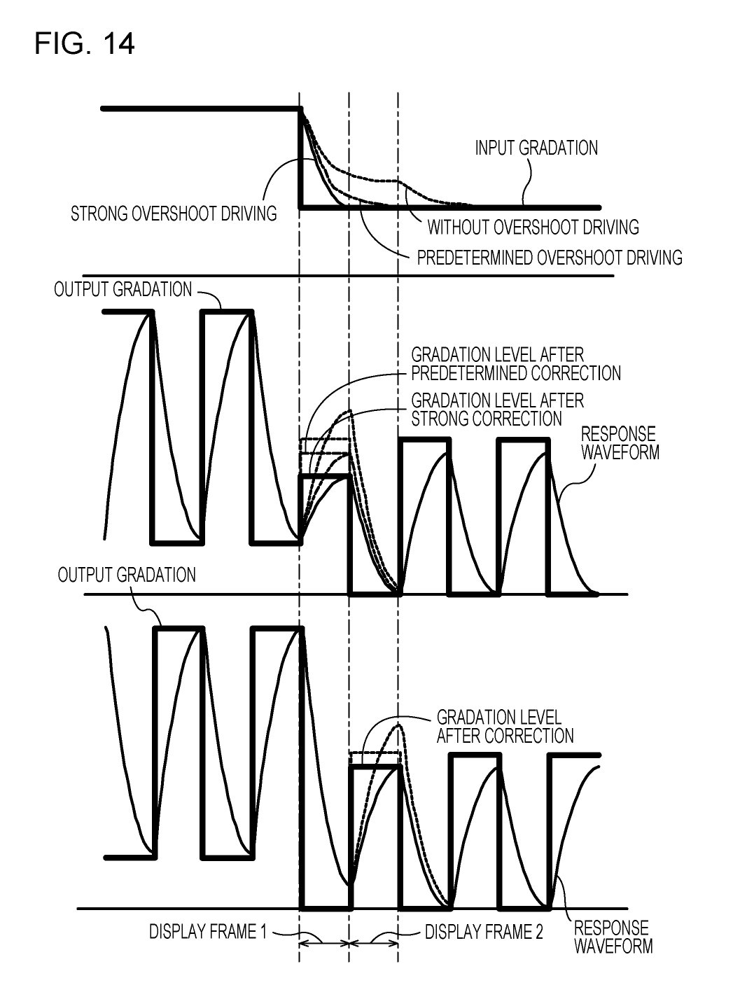

When the display mode 6 switches to the display mode 4, as shown in FIG. 14, the response of the liquid crystal is not completed during displaying period of the display frame 1. For this reason, the gradation to be originally displayed is not achieved. As a result, the luminance of the pixels is enhanced.

Here, the determination unit 22 determines whether or not there is a pixel that cannot perform overshoot driving in the display frame to be subsequently displayed.

The correction unit 24 corrects the gradation of a pixel located adjacent to a pixel which is determined by the determination unit 22 not to perform overshoot driving, to the gradation for which overshoot driving stronger than the predetermined overshoot driving is possible. As shown in FIG. 14, the gradation lower than the gradation in which the predetermined overshoot driving is performed is set as the target gradation. For this reason, overshoot driving stronger than the predetermined overshoot driving is performed. As a result, the luminance of the pixels deteriorated.

That is, it is possible to compensate for the enhanced luminance at the pixel where overshoot driving cannot be performed by deteriorating the luminance of the adjacent pixels. As a result, a change in the luminance of the entire display frame is suppressed.

The pixel which cannot perform overshoot driving in the display frame 1 can perform overshoot driving in the display frame 2. Therefore, in the display frame 2, overshoot driving is performed at the pixel where overshoot driving cannot be performed in the display frame 1.

If overshoot driving stronger than the predetermined overshoot driving is performed in the display frame 1, it is possible to obtain a waveform closer to the input gradation than a case where the predetermined overshoot driving is performed in the display frame 1.

### Application Example 1 of Embodiment

In the present application example, the determination unit 22 determines that overshoot driving cannot be performed even when a gradation of a high gradation display is a gradation close to a maximum gradation. Therefore, it is possible to make the luminance of the entire display frame close to a predetermined luminance.

### Application Example 2 of Embodiment

In the present application example, the determination unit 22 determines that overshoot driving cannot be performed even when a gradation of a low gradation display is a gradation close to a minimum gradation. Therefore, it is possible to make the luminance of the entire display frame close to a predetermined luminance.

The embodiments of the invention have been described in detail, but the embodiments are merely examples of the invention. The invention is not limited at all to the above-described embodiments at all.

For example, only when a gradation of an input image is an intermediate gradation, may the converting unit 18 convert the gradation of an input image to a gradation of a high gradation display and a gradation of a low gradation display.

In Table 1, in a case where the display mode 1 switches to the display mode 3 and in a case where the display mode 3 switches to the display mode 3, strong overshoot driving is performed. However, for example, in a case where the display mode 2 switches to the display mode 3, strong overshoot driving may be performed.

In Table 2, in a case where the display mode 4 switches to the display mode 4 and in a case where the display mode 6 switches to the display mode 4, strong overshoot driving is performed. However, for example, in a case where the display mode 5 switches to the display mode 4, strong overshoot driving may be performed.

### REFERENCE SIGNS LIST

10 Liquid crystal display apparatus

12 Liquid crystal panel

14 Viewing angle improvement unit

16 Processing unit

24 Correction unit

1. A liquid crystal display apparatus comprising:
a liquid crystal panel having a plurality of pixels disposed in a matrix pattern; and
a viewing angle improvement unit that performs a process of improving a viewing angle of the liquid crystal panel,
wherein the viewing angle improvement unit includes:
a processing unit that performs a high gradation display displaying a gradation higher than a gradation of an input image at one of two adjacent pixels, performs a low gradation display displaying a gradation lower than a gradation of an input image at the other of the two adjacent pixels, and switches between the high gradation display and the low gradation display for each pixel every display frame; and
a correction unit that corrects a gradation of a pixel located adjacent to a pixel displayed with a gradation for which predetermined overshoot driving is difficult in the next display frame to a gradation for which overshoot driving stronger than the predetermined overshoot driving is possible, and
wherein, when there is the pixel displayed with a gradation for which predetermined overshoot driving is difficult, the processing unit displays a pixel located adjacent to the pixel displayed with a gradation for which predetermined overshoot driving is difficult, with the gradation corrected by the correction unit.

2. The liquid crystal display apparatus according to claim 1,
wherein, when the gradation of an input image is lower than a threshold gradation, after performing the high gradation display with an intermediate gradation higher than a minimum gradation and lower than a maximum gradation, the processing unit performs the low gradation display with the minimum gradation,
wherein, when the gradation of an input image is higher than the threshold gradation, after performing the high gradation display with the maximum gradation, the processing unit performs the low gradation display with the intermediate gradation.

3. The liquid crystal display apparatus according to claim 2,
wherein the correction unit corrects a gradation of a pixel located adjacent to a pixel switched from the low gradation display when the gradation of an input image is lower than the threshold gradation to the high gradation display when the gradation of an input image is higher than the threshold gradation, to a gradation for which overshoot driving stronger than the predetermined overshoot driving is possible.

4. The liquid crystal display apparatus according to claim 2,
wherein the correction unit corrects a gradation of a pixel located adjacent to a pixel switched from the low gradation display when the gradation of an input image is higher than the threshold gradation to the high gradation display when the gradation of an input image is higher than the threshold gradation, to a gradation for which overshoot driving stronger than the predetermined overshoot driving is possible.

5. The liquid crystal display apparatus according to claim 2,
wherein the gradation for which predetermined overshoot driving is difficult is a gradation in a predetermined range including the maximum gradation.

6. The liquid crystal display apparatus according to claim 1,
wherein, when the gradation of an input image is lower than a predetermined threshold gradation, after performing the low gradation display with the minimum gradation, the processing unit performs the high gradation display with an intermediate gradation higher than the minimum gradation and lower than the maximum gradation,
wherein, when the gradation of an input image is higher than the threshold gradation, after performing the low gradation display with the intermediate gradation, the processing unit performs the high gradation display with the maximum gradation.

7. The liquid crystal display apparatus according to claim 6,
wherein the correction unit corrects a gradation of a pixel located adjacent to a pixel switched from the high gradation display when the gradation of an input image is lower than the threshold gradation to the low gradation display when the gradation of an input image is lower than the threshold gradation, to a gradation for which overshoot driving stronger than the predetermined overshoot driving is possible.

8. The liquid crystal display apparatus according to claim 6,
wherein the correction unit corrects a gradation of a pixel located adjacent to a pixel switched from the high gradation display when the gradation of an input image is higher than the threshold gradation to the low gradation display when the gradation of an input image is lower than the threshold gradation, to a gradation for which overshoot driving stronger than the predetermined overshoot driving is possible.

9. The liquid crystal display apparatus according to claim 6,
wherein the gradation for which predetermined overshoot driving is difficult is a gradation in a predetermined range including the minimum gradation.
